(19) United States
(12) Patent Application Publication
(10) Pub. No.: US 2011/0317448 A1
(43) Pub. Date: Dec. 29, 2011

(54) Low profile graphic display device and method

(76) Inventor: George O. Podd, Lake Forest, IL (US)

(21) Appl. No.: 13/136,526

(22) Filed: Aug. 3, 2011

Related U.S. Application Data
(63) Continuation-in-part of application No. 12/821,944, filed on Jun. 23, 2010.
Application No. 12/821,944 is a continuation-in-part of application No. 12/930,832, filed on Jan. 18, 2011.

(51) Int. Cl. G09F 13/04; B23P 11/00; F21V 8/00

(52) U.S. Cl. 362/628; 362/632; 29/428

(57) ABSTRACT

A low profile backlit graphic display device enables a user to display an illuminated graphic hung from the user's neck. The device comprises a housing, a light source assembly, and a number of optical element panels. The housing comprises housing edging, an assembly-receiving cavity, and a coupler-receiving aperture. The housing edging defines a panel-receiving section in anterior adjacency to the assembly-receiving cavity. The light source assembly is receivable in the assembly-receiving cavity. The panels may include a reflector panel, a light guide panel, and an interchangeable graphic panel. The panels are positionable in anterior adjacency to the assembly-receiving cavity within a panel-receiving section. The graphic panel is positionable in anterior adjacency to the light guide panel for illuminating a graphic by way of panel-guided light. A lanyard assembly is attachable to the coupler-receiving aperture and wearable about the neck for enabling the user to display a neck-hung illuminated graphic.

### BACKGROUND OF THE INVENTION

This patent application is a continuation-in-part patent application claiming the benefit of pending U.S. patent application Ser. No. 12/821,944 ('944 Application), filed in the United States Patent and Trademark Office on 23 Jun. 2010; and pending U.S. patent application Ser. No. 12/930,832 ('832 Application), filed in the United States Patent and Trademark Office on 18 Jan. 2011.

### FIELD OF THE INVENTION

This invention relates generally to a backlit graphic display device. More particularly, the present invention relates to a low profile graphic display device for illuminating interchangeable graphics panels for display in front of the user's chest or torso as hung from the neck by a lanyard assembly.

### DISCUSSION OF PRIOR ART

Various types of display devices are known in the art for displaying graphics and the like. Several relatively early disclosures describing variously pertinent display devices may be found in U.S. Pat. No. 2,557,383 (Kerwer); U.S. Pat. No. 4,264,979 (Gutowski); U.S. Pat. No. 4,443,832 (Kanamori et al.); and U.S. Pat. No. 4,574,269 (Miller).

U.S. Pat. No. 4,603,065 ('065 Patent), which issued to Mori, et al., discloses a Decorative Part. The '065 Patent describes an aesthetically treated indication comprising a first indicator which permits the transmission of light, a semitransparent part placed behind the first indicator which reflects the light coming from the front and passes the light coming from the rear, a second indicator which permits the partial transmission of light and is placed behind the semitransparent part, and an illuminant placed behind the second indicator. Thus, it is possible to switch the display of the decorative part as desired by turning on and off the illuminant at proper time.

U.S. Pat. No. 4,709,307, which issued to Branom, discloses certain Clothing with an Illuminated Display. The '307 Patent describes an article of clothing comprising a shell forming an outer layer of the article, a liner disposed generally inside the shell and forming an inner layer of the article, and a set of light-emitting diodes or the like forming a predetermined pattern on the exterior of the article of clothing.

The set of light-emitting diodes is mounted on a substrate. A power source is provided for illuminating the diodes, as is a control circuit for controlling the energization of the diodes. There is a pocket in the article of clothing in which the power source is removably disposed. A cable electrically connects the diodes and the power source, which cable is disposed generally between the shell and the liner so as to be hidden from view and protected. An overlay has imprinted thereon a pattern corresponding to the predetermined pattern of the diodes. The overlay has openings therethrough through which the diodes extend, and the overlay is secured to the shell.

U.S. Pat. No. 5,005,306 ('306 Patent), which issued to Kinstler, discloses an Illuminated Vehicle Sign. The '306 Patent describes an illuminated vehicle display apparatus having a flexible electroluminescent panel having a front planar surface which directly generates illumination when excited by an alternating current. A thin flat flexible opaque shield has cutout areas to form designs therein and is attached over the electroluminescent panel planar surface so that portions of the panel are visible through the opaque shield so that indicia and graphic designs are defined by the visible electroluminescent light.

A thin flexible magnetic sheet of material is attached over the rear surface of the electroluminescent panel for removably attaching the vehicle sign to the side of a vehicle. The electroluminescent panel has a pair of conductors coupled thereto and through a DC to AC converter and is attached to the vehicle battery, such as through the vehicle cigarette lighter. A pair of panels may be attached to both sides of the vehicle on the doors adjacent the door hinge so that the conductors pass through the hinged area and are attached to a common cigarette lighter plug for powering panels on each side of the vehicle simultaneously.

U.S. Pat. No. 5,516,387 ('387 Patent), which issued to Hoffman, discloses an Illuminated Sign and Method of Assembly. The '387 Patent describes an improved illuminated sign for adhesive bonding to the inner surface of a pane of transparent material such as the glass of an automotive window comprises a backing panel, a planar electroluminescent lamp, and an indicia-bearing member. The indicia-bearing member is smaller in planar extent than an assembly of the backing panel and the lamp. Strips of double-sided adhesive tape are applied to the border of the backing panel. The second adhesive surface of the tape is used to bond the assembly of the backing panel, the lamp and the indicia-bearing member to the inner surface of an automobile window or the like.

U.S. Pat. No. 5,845,987 ('987 Patent), which issued to Painter, discloses an Illuminated Accessory and Device. The '987 Patent describes an illuminated accessory and device including a hat that has a panel attached to the front section of the crown of the hat. The panel has indicia formed from a silk-screened polymer film overlay. The panel is formed of a flat electro-luminescent lamp that has the shape of the indica and provides illumination. The lamp has a ribbon extension to a female connector. Included is an inverter positioned within the pouch of the crown of the hat. The inverter has a male connector at one end to couple with the female connector of the lamp. The inverter is in connection with a switch and power source. The inverter is adapted to supply AC line current from the power source to the panel for illumination of the indicia.

U.S. Pat. No. 6,640,474 ('474 Patent), which issued to Knoerzer et al. discloses a Trading Card and Display Stand. The '474 Patent describes a trading card having an electroluminescent feature in combination with a display stand providing a power source. When the trading card is placed in the display stand, the power source from the display stand energizes the electroluminescent feature of the trading card, thereby providing illuminated graphics and making the trading card more interactive. The trading card can include a circuit that facilitates moving graphics displays and can further drive a speaker to allow for audio in conjunction with the illumination.

U.S. Pat. No. 6,672,748 ('748 Patent), which issued to Baldwin discloses a Back Lighted Display Unit. The '748 Patent describes an illuminated back-lighted display unit that is capable of displaying a variety of different types of artwork, messages, logos, or pictures in various applications within a home, commercial building, vehicle, or anywhere a miniature back-lighted display is desired. The display unit has a main housing which contains a light source that may include a diffuser and a cover lens or glass that includes one or more layers of the artwork to be displayed. The cover glass is trimmed with a trim bezel, and when assembled, the unit is provided with some means of mounting the assembly to the window or other structure through which it will be viewed.

U.S. Pat. No. 7,065,909 ('909 Patent), which issued to Snyder, discloses a Portable Animated Illuminated Panel Display Device. The '909 Patent describes a device arranged to be mounted on various items, such as windows of vehicles or businesses or on garments. The device includes an illuminatable display panel, e.g., an electroluminescent, OLED, LCD or LED panel, and an associated driver/control unit. The display panel is made up of various illuminatable areas or segments arranged to be illuminated in a predetermined pattern and sequence by the driver/control unit to produce an animated display of graphic and/or text.

U.S. Pat. No. 7,883,253 ('253 Patent), which issued to Wang, discloses a Backlight Module. The '253 Patent describes a backlight module which comprises at least a light-guide plate, a palette device and an LED bar. The palette device comprises a palette and light-guide bar and at least one palette LED. The palette and light-guide bar is disposed at a side end of the light-guide plate and has a light-input surface, a light-output surface corresponding to the light-input surface, a first side, a second side corresponding to the first side, a top, and a bottom corresponding to the top.

The palette LED is adjacent to the first side and provides a palette light into the palette and light-guide bar. The LED bar is adjacent to the light-input surface of the palette and light-guide bar. The LED bar emits an incident light, which is through the light-input surface into the palette and light-guide bar, wherein a light mixed by the incident light and the palette light is output through the light-output surface is and the side end into the light-guide plate so as to be a light source of the backlight module.

United States Patent Application Publication No. US 2006/0103638 (See also US 2008/0285219; and US 2009/0033648), was authored by Podd (et al.), describes a light film apparatus having an illuminated graphics panel with at least two segments that can be individually powered. A controller manages a power which is delivered from a power supply to each of the segments, so that each of the segments is either powered on, powered off or powered to an intermediate level. With the independent control of power to the different segments, it is possible to create a three-dimensional appearance of a moving image from a generally two-dimensional panel arrangement.

While the above referenced patent disclosures are directed to illuminated display devices, none of the display units disclosed are suitable for mounting around a user's neck for displaying graphics upon the chest or otherwise in anterior adjacency to the user's torso. In this regard, it is noted that identification tags or passes are often worn around the neck of the user for enabling the user to easily provide tag or pass identification to would-be requestors or passersby. The prior art appears to be silent on a neck-worn or neck-hung graphic display unit or device for illuminating graphics thus made easily viewed upon the user.

The present invention has been developed so as to improve upon neck-hung pass or tag state of the art by providing a low profile backlit graphic display unit or device suitable for illuminating logos, photos, or similar other graphics. There would appear to be an ongoing need in the art(s) for developing improvements to illuminated displays of the foregoing types, and in this respect, it is contemplated that the present invention addresses these long felt needs and interests.

### SUMMARY OF THE INVENTION

As noted in the '944 and '832 Applications, there is a perceived need in the art(s) for enhanced visibility of graphic elements not only for marketable applications, but also for reasons of safety. For example, as has been demonstrated in the '944 and '832 Applications, enhanced visibility of graphic elements as displayed upon vehicles may help overcome low visibility driving conditions, such as snow, rain, darkness and/or fog. With increased visibility of specific graphic elements on a vehicle, other motorists can better see dedicated information, particularly in adverse weather conditions or low visibility driving conditions.

The neck-worn graphic display device according to the present invention can be used in any suitable or desirable situation or format, such as a safety signal, a public service symbol including symbols of the Department of Transportation, the Military, the National Guard, the Police and the Fire Departments, as construction signage, a zone authority, a help/warning message, and many other marketable applications, including zone parking passes for major events, promotional icons, brand logos and advertising messages.

The graphic display device according to the present invention incorporates a light guide panel for directing edge-received light anteriorly through a translucent graphics panel. The graphic display device further incorporates a lanyard assembly for enabling the user to wear the graphic display device upon one's person as hung from the neck to allow themed graphics, such as words, logos and/or symbols, to be readily visible.

In other embodiments according to this invention, the graphic display device can be used to display the appearance of a moving image. For example, a graphic display device according to the present invention can be used to display a dynamic or moving flag, or to give the appearance that the flag is blowing in the wind. It is contemplated that the creation or animation of a moving image can be accomplished with a translucent lenticular graphics panel.

A product of this invention may be easy to use, require low maintenance and operate within control module settings and functional parameters. For example, a motion sensor, a light sensor and/or a timer switch can be used to make all necessary or desired adjustments, so that the user does not have to use or address the on/off switch once a desired operational mode is set. The user may have an option to change a mode setting. A battery recharge capability, particularly if automatic, allows the user to not be concerned with replacing or manually recharging batteries. A removable battery module provides a simple battery replacement operation.

A product according to this invention can be manufactured and operate within a range of reasonable costs, based on potential market applications. An interchangeable translucent graphic panel and layer assembly allows the light guide illumination assembly components to provide standardized back light. Thus, custom printing of clear plastic sheet material minimizes the cost, the inventory and the production time. Sensors optimize product function, provide a user-friendly product and prolong battery life during use. There can be a battery recharge capability with, for example a solar panel option, to prolong battery life.

With a product according to this invention, consumers may obtain value added attributes of increased visibility for their specific needs. Also, the consumer is able to use the graphic display device according to the present invention and benefit from improved user features and cost effective operation. The graphic display device may include a static or constant display or illumination and/or a dynamic or animated graphic display or illumination.

### BRIEF DESCRIPTION OF THE DRAWINGS

Other features of my invention will become more evident from a consideration of the following brief descriptions of patent drawings:

FIG. 1 is an anterior view of the graphic display device according to the present invention as neck-hung by a fragmentary phantom user depicted in broken lines.

FIG. 1(a) is a fragmentary transverse sectional view of the graphic display device as positioned in anterior adjacency to the sternal region of a user as sectioned from FIG. 1.

FIG. 1(b) is a fragmentary longitudinal sectional view of the graphic display device as positioned in anterior adjacency to the sternal region of a user as sectioned from FIG. 1.

FIG. 2 is a top anterior perspective view of a first alternative graphic display device according to the present invention shown in exploded relation adjacent a first alternative graphic panel removably retainable by the first alternative graphic display device.

FIG. 3(a) is a top anterior perspective view of a second alternative graphic display device according to the present invention shown with a second alternative graphic panel being removably received by the second alternative graphic display device, as attached to a fragmentary lanyard assembly.

FIG. 3(b) is a top posterior perspective view of the second alternative graphic display device according to the present invention.

FIG. 4 is a top anterior exploded perspective view of the first alternative graphic display device according to the present invention shown with the first alternative graphic panel in relative positioned placement.

FIG. 4(a) is an enlarged fragmentary view of a superior edge projection of a light guide panel according to the present invention depicting a light emission axis being directed orthogonally against an angled edge of the superior edge projection.

FIG. 5 is an exploded lateral edge type view of the first alternative graphic display device according to the present invention shown with the first alternative graphic panel in relative positioned placement.

FIG. 5(a) is an enlarged fragmentary sectional view as sectioned from FIG. 5 to depict a multi-layered panel-receiving section of the posterior housing section of the graphic display device according to the present invention.

FIG. 6 is a lateral edge type view of the first alternative graphic display device according to the present invention with certain structures shown in broken lines to depict various layers of material otherwise hidden from a lateral view.

FIG. 7 is a front plan view of the posterior housing section shown with a fragmentary phantom light guide panel (in broken lines) and a fragmentary phantom light source assembly 9 in broken lines) positioned adjacent a superior edge of the posterior housing section to depict relative positioned placement of the structures.

FIG. 7(a) is an enlarged fragmentary sectional view as sectioned from FIG. 7 to more clearly depict the structural configuration of the upper or superior portions of the posterior housing section, light guide panel, and light source assembly in solid lining.

FIG. 8 is a diagrammatic side view depiction of three layers of optical element material panels, namely, from top to bottom: a diffuser panel, a light guide panel, and a reflector panel.

FIG. 9 is a front plan view of the light guide panel according to the present invention positioned adjacent laterally opposed light emitting diodes (LED's) and depicting an increasing light exit structure density opposite the positioned LED's.

FIG. 10(a) is a first enlarged fragmentary longitudinal sectional view as sectioned from FIG. 4 depicting various boundary layers of the panel-receiving section of the posterior housing section.

FIG. 10(b) is a second enlarged fragmentary longitudinal sectional view as sectioned from FIG. 4 depicting various boundary layers of the panel-receiving section and assembly-receiving cavity of the posterior housing section.

FIG. 11 is a lateral elevational view of the first alternative graphic display device according to the present invention shown exploded from the first alternative graphic panel depicted in planar solid lining and bent phantom lining.

FIG. 11(a) is a first enlarged fragmentary sectional view as sectioned from FIG. 11 to depict a material (graphic) layer upon an anterior surface of the first alternative graphic panel.

FIG. 11(b) is a second enlarged fragmentary sectional view as sectioned from FIG. 11 to depict a material (graphic) layer upon a posterior surface of the first alternative graphic panel.

FIG. 12 is a diagrammatic depiction of a fragmentary phantom user in broken lines depicted wearing a neck-hung graphic display device and exposed to solar energy for providing a power source to the light source assembly of the graphic display device.

FIG. 12(a) is an enlarged fragmentary sectional view as sectioned from FIG. 12 to depict a tag outfitted with a thin film solar cell material for collecting solar energy and directing electrical energy from converted solar energy to the light source assembly of the graphic display device according to the present invention.

FIG. 13 is a diagrammatic depiction of a lanyard structure outfitted with a thin film solar cell material in electrical communication with an electrochemical power source for powering the light source assembly of the graphic display device according to the present invention.

FIG. 13(a) is an enlarged fragmentary plan type view as sectioned from FIG. 13 to more clearly depict a thin film solar cell material in solar side adjacency to the lanyard material.

FIG. 13(b) is an enlarged fragmentary sectional view as sectioned from FIG. 13 to more clearly depict a thin film solar cell material in layered adjacency to the lanyard material.

FIG. 14 is a posterior plan view of a third alternative graphic display device according to the present invention depicted as being outfitted with an optional thin film solar cell material for recharging a phantom electrochemical power source (depicted in broken lines).

FIG. 14(a) is a lateral side view of the third alternative graphic display device otherwise depicted in FIG. 14.

FIG. 14(b) is an inferior edge view of the third alternative graphic display device otherwise depicted in FIG. 14.

FIG. 14(c) is an enlarged fragmentary sectional view as sectioned from FIG. 14(a) to depict thermal bonding of the anterior housing section to the posterior housing section at the outer edging thereof.

FIG. 15 is an anterior plan view of a fourth graphic display device according to the present invention.

FIG. 16 is a posterior plan view of a fifth graphic display device according to the present invention.

FIG. 16(a) is a lateral edge view of the fifth graphic display device otherwise depicted in FIG. 16.

### DETAILED DESCRIPTION OF THE PREFERRED EMBODIMENTS AND METHOD

Referring now to the drawings with more specificity, the present invention essentially provides a neck-hung or neck-worn graphic display device as at reference numerals 10, 10′, and 50, which devices employ certain light guide technology to illuminate a graphic panel as at 11 or 11′ removably and/or interchangenably positioned in anterior adjacency to the anterior illumination surfacing of the graphic display devices 10/10′/50. Certain developmental similarities and certain developmental distinctions can be traced to, or otherwise seen when compared to certain prior filed U.S. patent applications from which this specification claims a benefit.

In this last regard, and as noted hereinabove, the present specification(s) claim the benefit of pending U.S. patent application Ser. No. 12/821,944 ('944 Application), filed in the United States Patent and Trademark Office on 23 Jun. 2010; pending U.S. patent application Ser. No. 12/930,832 ('832 Application), filed in the United States Patent and Trademark Office on 18 Jan. 2011, and all other application-based subject matter in proper continuity with the '944 and '832 Applications. The specifications of the '944 and '832 Applications, as well as all disclosed subject matter in proper continuity therewith are hereby incorporated by reference thereto.

It is contemplated that the graphic display devices 10/10′/50 according to the present invention have particular applicability within the entertainment, concert, holiday celebration, election or campaign promotional activities, and sports promotion markets. The graphic display device(s) 10/10′/50 according to the present invention provide a neck-wearable illuminated graphics panel (as at 11 and 11′) that is slim, lightweight and comfortable to wear at any venue indoors or outdoors. The product offers multiple versions and features, including a cost effective thermal form or heat sealed polymeric housing with simple open-close circuit (mechanical switch operated).

The graphic display device(s) 10/10′/50 according to the present invention allow a printed or otherwise marked graphic panel 11 (and 11′) to be removably installed and backlit. The graphic display devices 10/10′/50 integrate a lanyard-receiving or coupler-receiving hang hole or aperture as at 18 to attach a lanyard neck strap assembly as at 19. The graphic display devices 10/10′/50 may incorporate an optional auxiliary ticket and/or coupon storage pouch, and are contemplated to be operable in a variety of shapes and sizes.

For example the shapes may include generally rectangular shapes as seen in devices 10 and 10′ or generally circular shapes as seen in device 50. Custom shapes are also conceivable. For example, the end user may require the shape to resemble the shape of a company logo. In terms of the size restrictions, it is noted that although any number of sizes are possible, neck supported objects having too great a size may become unwieldy and/or uncomfortable and/or unsafe.

Certain methodology otherwise associated with the low profile graphic display devices 10/10′/50 is further contemplated since neck worn devices necessarily must be of relatively low weight and low profile if comfortability and safety are to be enhanced. Prior or state of the art graphic display devices typically lack the low weight, low profile specifications, and thus the present invention attempts to address these perceived needs in the arts.

The low profile backlit graphic display devices 10/10′/50 according to the present invention thus essentially function to enable a user to display an illuminated graphic in anterior adjacency to the user's sternal region (as at 100) or otherwise along the medial plane (as at 103) intermediate laterally opposed pectoral regions (as at 101). To achieve this basic function, the graphic display devices 10/50 according to the present invention preferably comprise: a posterior housing section as at 12; a light source assembly as at 13; a reflector panel as at 14; a light guide panel as at 15; a diffuser panel as at 16; at least one interchangeable graphic panel as at 11; and an anterior housing section as at 17.

The posterior housing section 12 is preferably formed from polymeric material(s) via a thin wall injection molding process and comprises a top posterior housing edge or portion as at 20; a bottom posterior housing edge or portion as at 21; and laterally opposed posterior housing edges or portions as at 22. The backing structure 23 of posterior housing section 12 defines an assembly-receiving cavity as at 24, which cavity 24 is sized and shaped to closely conform to the external surfacing of the light source assembly 13 so as to minimize the overall volumetric space requirements for the device(s) 10/10′/50.

The posterior housing edges or portions 20-22 define an optical element or light diffuser panel-receiving section or cavity portion 25 which section or portion 25 comprises a certain depth as at 104 for accepting multiple layers of material as employed in the various panels 14, 15, and 16, and all of which are substantially planar in overall configuration, but each of which have a certain minimized thickness so as to achieve the overall low profile characteristic of the device(s) 10/10′/50. The optical element or light diffuser panel-receiving section or portion 25 is situated in anterior adjacency to the assembly-receiving cavity 24, and is essentially defined by the open volumetric space intermediate planes 105 and 106 and defined by edging 20, 21, and 22.

The top posterior housing edging or portion 20 preferably comprises a medial posterior lanyard-receiving aperture as at 33 for receiving a coupler device otherwise associated with the lanyard (neck strap) assembly 19. Further, in a preferred embodiment, the assembly-receiving cavity 24 preferably comprises a switch-letting aperture as at 26 for accepting and/or letting a manual switch knob 27 made integral with the light source assembly 13. The switch knob 27 enables the user to manually switch ON or OFF the light source assembly 13 by closing or opening the integrated circuit made part of the light source assembly 13.

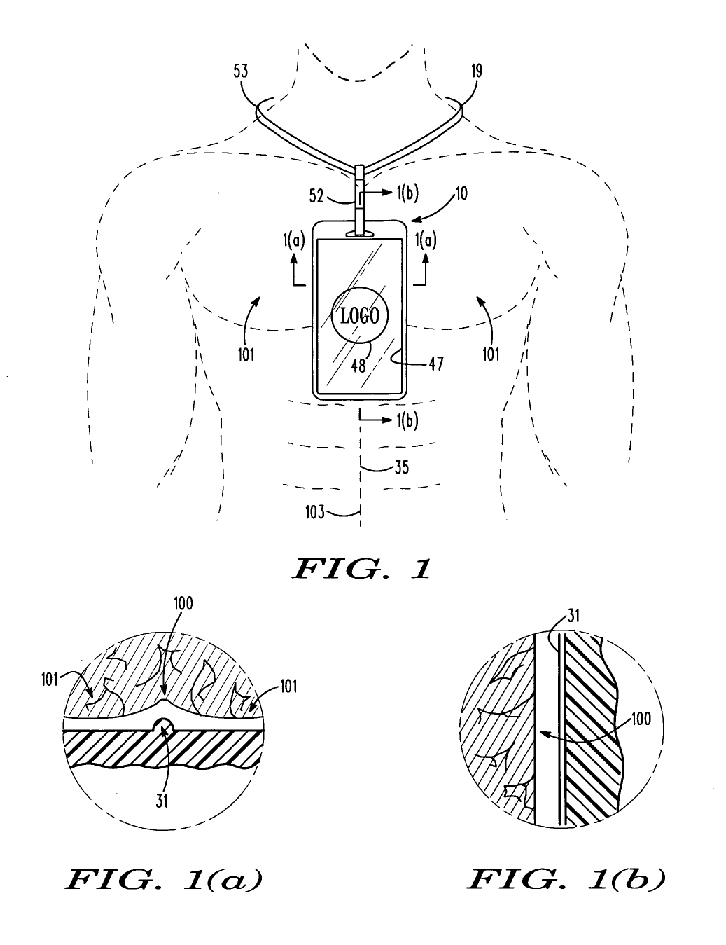

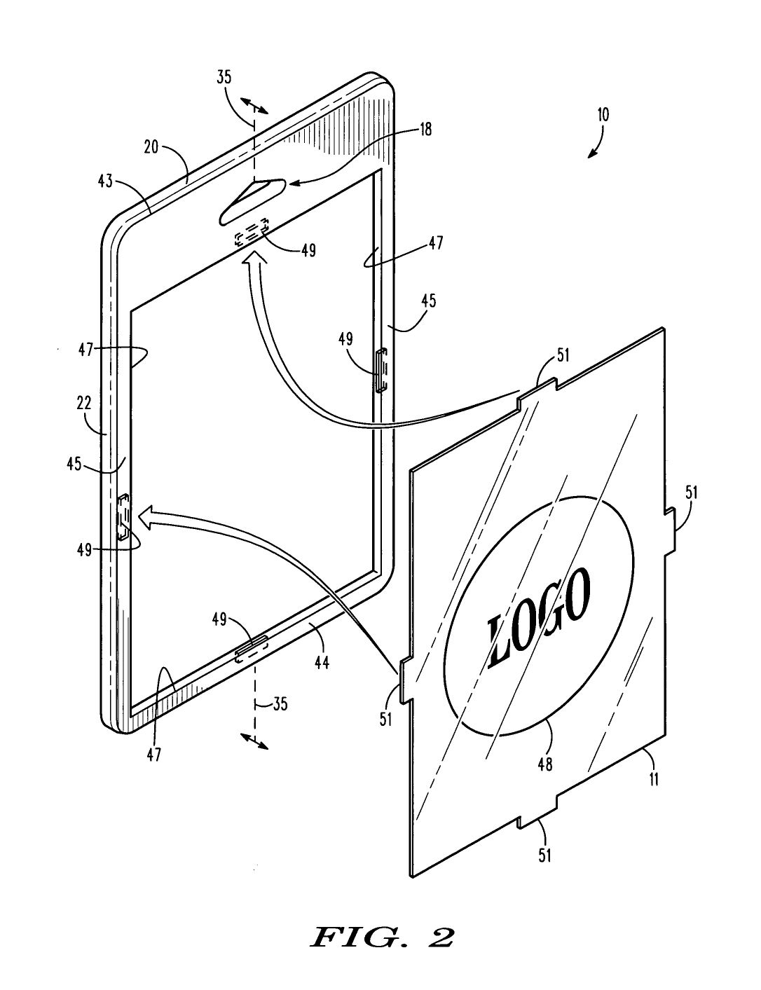

The posterior housing section 12 further preferably comprises a posteriorly extending narrow bead structure as at 31, which narrow bead structure 31 extends posteriorly along the medial plane as at 35. Anteriorly, the narrow bead structure 31 defines a cavity 32 the posterior terminus of which is coplanar with plane 107 for receiving portions of the light source assembly circuitry as at 36. Posteriorly, the narrow bead structure 31 may be utilized to center the posterior housing section 12 of the graphic display devices 10/10′/50 in anterior adjacency to the user's sternal region 100 (or otherwise along the medial plane 103) when donned. In other words, the sternal region 100 may be viewed as a bead-receiving valley type region for receiving the narrow bead structure 31 for proper positioned placement of the graphic display devices 10/10′/50 as generally depicted in FIGS. 1, 1(a), and 1(b).

Certain embodiments of the graphic display device (e.g. embodiments 70 and 80) may alternatively comprise a posteriorly extending structure as at 71, which structure 71 is relatively wider in lateral dimension as compared to the narrow bead structure 31. The structure 71 is approximately the same width as the battery compartment structure 72 for stepping or decrementing the posteriorly extending structure toward the surface 73. The lateral width of structure 71 enables the user to laterally stabilize the embodiments 70 and/or 80 medially relative to the pectoral regions 101 while enabling the coupler mechanism as at 52 to be centered in superior adjacency to the sternal region 100.

Embodiments 70 and/or 80 further preferably comprise an offset or raised lanyard receiving structure as at 74. The raised lanyard receiving structure 74 is believed to well receive a coupler structure as at 52 and is angled or rounded at the top of the aperture 75 for enabling the coupler 52 to be received within the angled or rounded portion 76 so that the lateral portions of the embodiments 70 and/or 80 hang symmetrically about the medial plane 35.

In addition to the features already noted, the light source assembly 13 preferably further comprises a ((n) electrochemical battery type) power source as generically depicted at 28, at least one light source as preferably exemplified by one or more light-emitting diodes (LED's) as at 29; a (manual) switch as exemplified by switch knob 27, and circuitry (as at 36) for placing the light source(s) or diodes 29 into electrical communication with the power source 28 via the manually operable switch knob 27.

The light source assembly 13 is receivable in the assembly-receiving cavity 24 such that the switch knob 27 extends through the switch-letting aperture 26, and the light source is positionable adjacent a select edge selected from the group consisting of the top, bottom, and side posterior housing edges 20-22. While the drawings depict the light sources being positionable adjacent the top posterior housing edging 20, it is contemplated that the light source or sources could conceivably be positioned at any number of points around the periphery of the posterior housing section 12.

In a first, preferred embodiment of the present invention, it will be seen that the posterior housing section 12 and anterior housing section 17 together define a rectangular graphic display device as at 10 and 10′. An alternative, generally round or circular embodiment is illustrated and referenced at 50 in FIGS. 15, 15(b), and 15(c). As earlier noted, any number of shapes and sizes are contemplated, including custom shapes and sizes as required by the end user. The preferred embodiment comprises certain notable features that may be carried over to alternative embodiments regardless of the overall shape or size of the device.

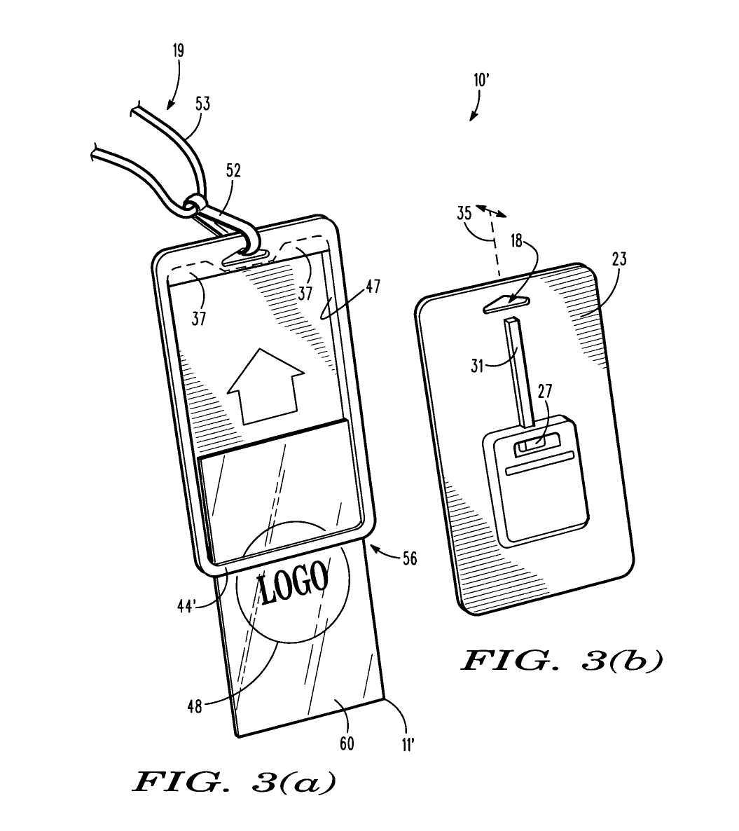

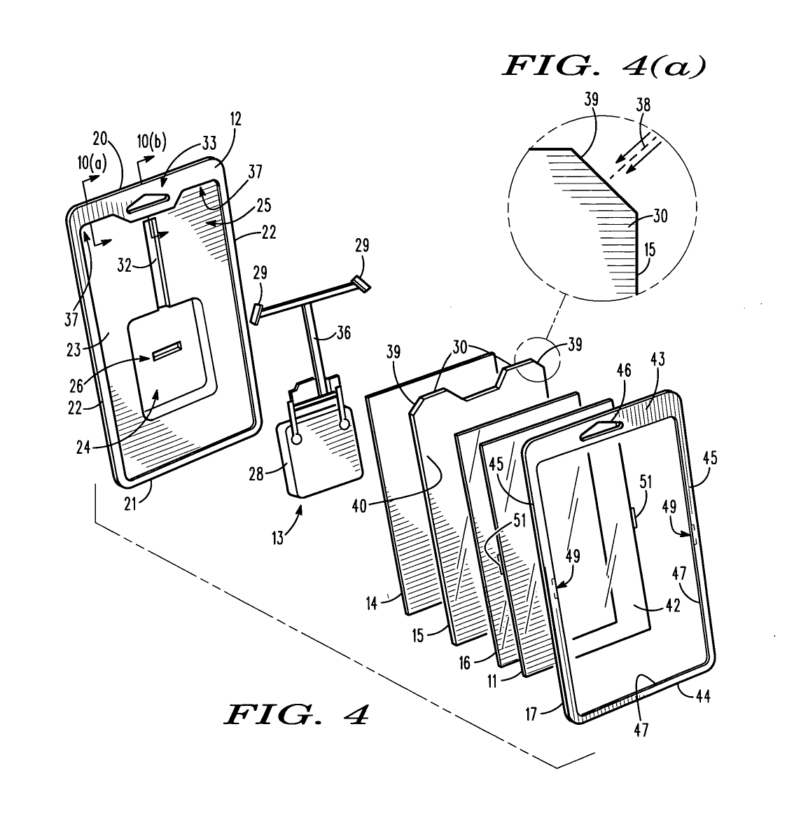

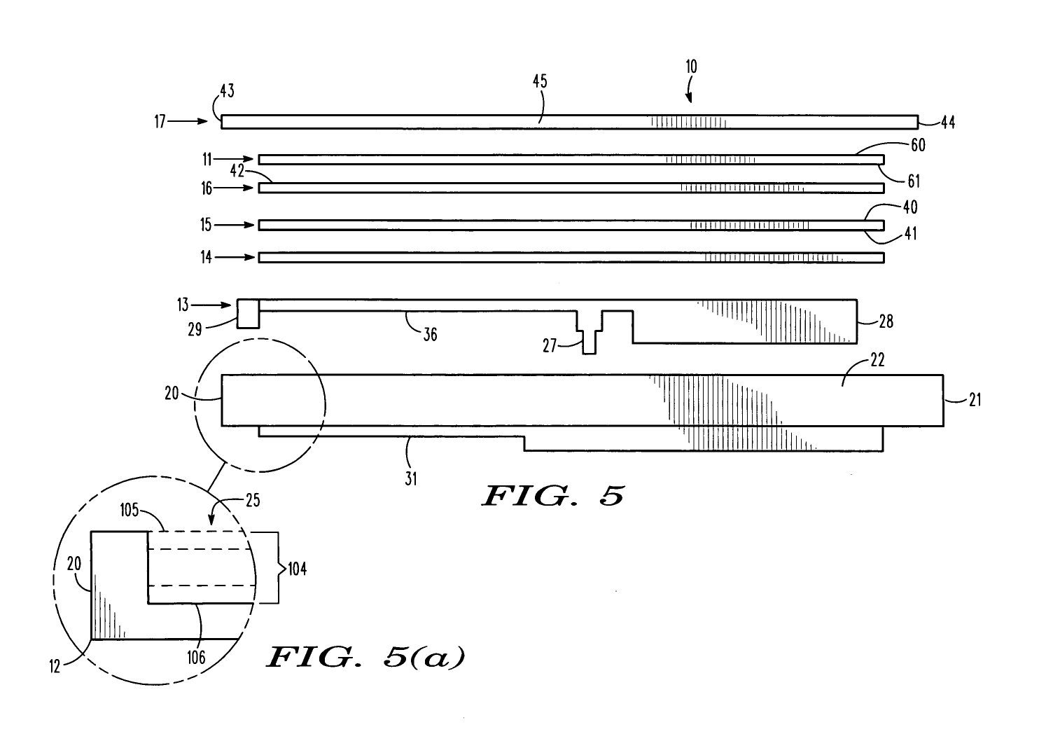

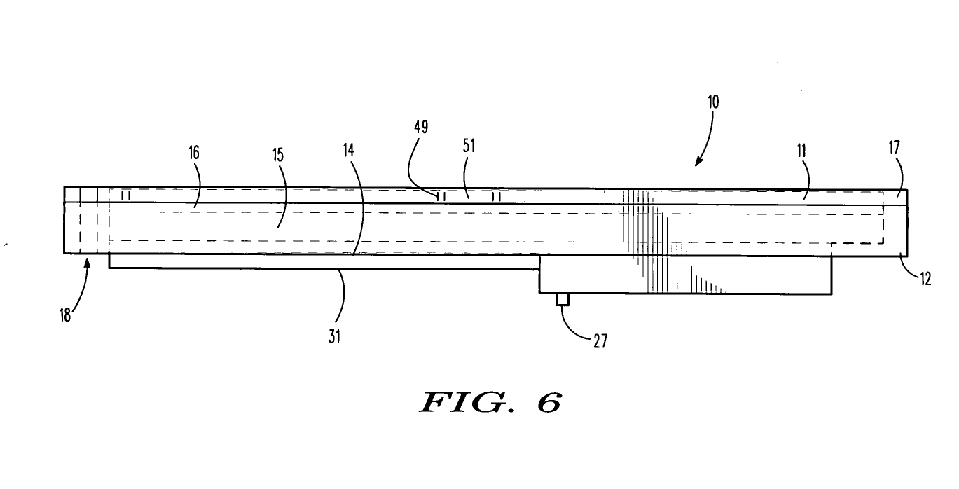

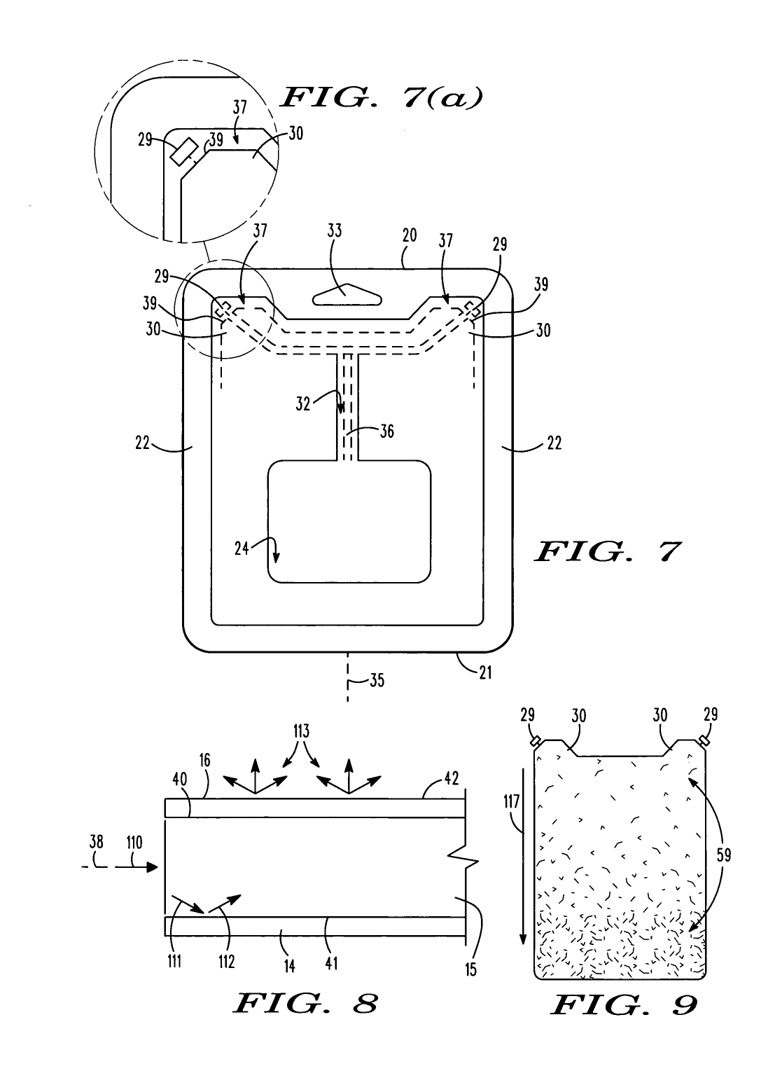

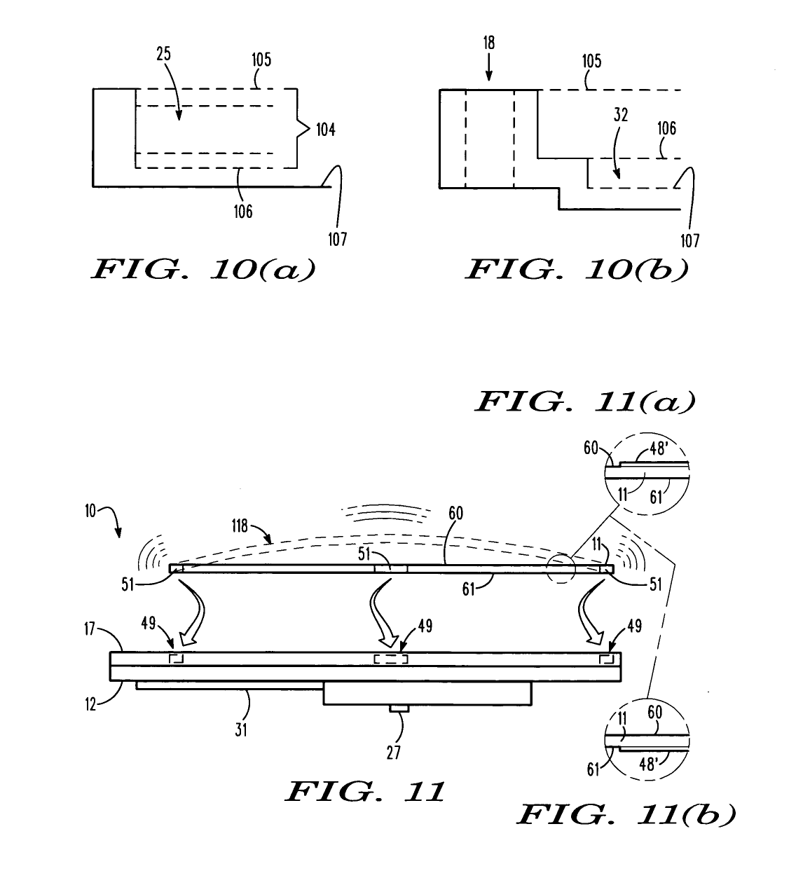

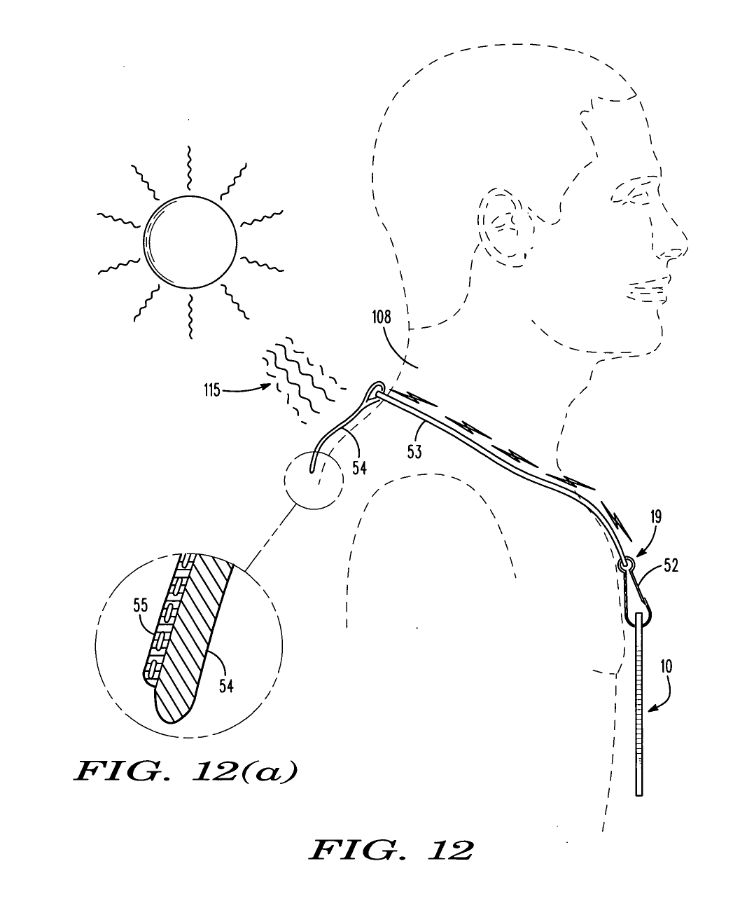

As may be seen from an inspection of FIGS. 3(a), 4, 7, and 7(a), the graphic display devices 10 and 10′ preferably comprise laterally opposed nooks, pockets or cavities as at 37 for receiving laterally opposed light sources as exemplified by certain light emitting diodes 29 as well as laterally opposed light guide projections 30. The noted laterally opposed structures are contemplated to oppose a medial plane as at 35 at which the coupler-receiving aperture 33 is located. The coupler-receiving aperture 33 is located at the medial plane 35 so that the device 10 may hang symmetrically thereabout when worn around the user's neck 108 and hung via the lanyard assembly 19.

To accommodate the aperture 33 (and thus aperture 18), the light sources 29 and light guide panel 15 are accordingly configured substantially as illustrated. Note, however, that the light emitting diodes 29 are positioned such that the directed light emission axes 38 are directed toward the medial plane 35 substantially at 45 degree angles relative to the plane 35. The light entering edges entrance planes 39 of the light guide panel 15 are preferably formed so as be orthogonal to the light emission axes 38 so as to minimize Fresnel loss and enhance light guidance throughout the light guide panel 15 to the light guide exit structure(s) as at 59.

Certain preferred structural arrangements bear repeating here in terms of summarizing the upper portion(s) of the devices 10/10′/50. As earlier noted, the light-diffuser panel-receiving section 25 is defined by the open volumetric space extending intermediate planes 105 and 106 of the posterior housing section 12. Portions of the panel-receiving section 25 are further sub-defined by the cavities 37, which cavities 37 are laterally opposite the posterior lanyard-receiving aperture 33.

The light source, being preferably defined by laterally opposed light emitting structures or diodes 29, function to source light in a medial direction or medially toward the medial plane 35. Further, the light guide panel 15 preferably comprises angled upper edging as depicted and referenced at 39. The light emitting diode structures 29 each comprise a primary light emission axis as at 38 such that the angled upper edging 39 is orthogonally opposed to the primary light emission axes 38 for enhancing light flux guidance through the light guide panel 15.

To further enhance light guidance, it is contemplated that the light guide panel 15 be constructed such that the density of the light guide exit structure (as depicted by stippling 59) generally increases (as at vector 117) as a function of (increased) distance and/or orientation of the light source(s) as generally depicted in FIG. 9. In other words, depending on the custom shape and size of the graphic display device, the light guide panel 15 may be formed so as to anticipate light source placement and orientation. In this regard, light guide entrance surfacing (as at edging 39) and light guide exit structure density may be tailored accordingly so as to enhance the diffusion of light from the anterior surface 40 of the light guide panel 15.

Light (as at rays 110) from the light sources 29 is preferably directed into the light guide panel 15, which panel 15 is preferably positioned in anterior adjacency to a reflector panel 14. The reflector panel 14 is thus preferably positioned slightly posterior to the primary light emission axis or axes 38 so as to reflect downwardly directed light (as at 111) anteriorly (as at 112) for further minimizing Fresnel loss and directing light back into the light guide panel 15 for enhancing anteriorly directed light guidance.

Conceivably, a light reflective coating could be applied to the posterior surface 41 of the light guide panel 15 so as to provide a similar function. In either structural scenario, however, the light sources are positioned such that light 110 enters the edging 39 of the light guide panel 15 and thus the anterior and posterior planes or surfaces 40 and 41 (respectively) of the light guide panel 15 are oriented such that the light emission axes 38 extend intermediate said planes 40 and 41 in parallel relation thereto.

The graphic display devices 10/10′/50 further preferably comprises a diffuser panel as at 16 for presenting random critical angles to internal light rays, assuring the probability of light escape from the light guide panel 15. The exiting light rays as at 113 are disbursed at random angles into a wide radiation pattern of light for enhancing light guidance from the light guide panel 15 into media placed in anterior adjacency to the diffuser panel 16.

In other words, the diffuser panel 16 is positionable in anterior adjacency to the light guide panel 15 in posterior adjacency to the interchangeable graphic panel 11 (or 11′) for enhancing uniform light transmission through the panel 11 or 11′ for improving the visual appearance thereof. It is contemplated that the anterior surface 42 of the diffuser panel 16 essentially fills the light diffuser panel-receiving section 25 and/or is coplanar with the boundary plane 105 of the posterior housing section 12.

The anterior housing section 17 is preferably formed from polymeric material(s) via a thin wall injection molding process and preferably comprises a top anterior housing edge 43; a bottom anterior housing edge 44; and laterally opposed side anterior housing edges as at 45. The top anterior housing edge 43 preferably comprises a medial anterior lanyard-receiving or coupler-receiving aperture as at 46. The anterior and posterior housing sections 17 and 12 are fastenable to one another such that the anterior and posterior lanyard-receiving apertures 46 and 33 together define a coupler-receiving aperture as at 18. It is contemplated that the sections 12 and 17 may be either snap fit fastened (not specifically illustrated) or thermally bonded or heat sealed as generally depicted and referenced at 116 in FIG. 15(c).

The anterior housing section 17 further comprises an inner peripheral edge 47, which edge 47 defines a viewing boundary for the graphic panel 11. The graphic panel 11 is removably or interchangeably positionable in anterior adjacency to the light guide panel 15 (and optional diffuser panel 16) and thus in anterior adjacency to the light diffuser panel-receiving section 25 thereby within the viewing boundary.

The graphic panel 11 is preferably formed from a light-transmissive material and comprises certain illuminatable artwork or similar subject matter as generically depicted with logo symbol 48 such that light rays 113 directed anteriorly therethrough from the light guide panel 15 illuminate the artwork. It is contemplated that the artwork or similar other matter may be layered either upon the anterior surface 60 or posterior surface 61 of the graphic panel 11 (or 11′) as comparatively depicted in FIG. 11(a) versus FIG. 11(b). Excellent results have been achieved by placing the printed layer (as at 48′) upon the posterior surface 61, the artwork itself acting to diffuse light and enhance visibility of the artwork.

The anterior housing section 17 further preferably comprises at least one pair of opposed wing-receiving notches 49 at the inner peripheral edging 47. In this regard, it should be noted that the interchangeable graphic panel 11 is preferably formed from a flexible, resilient material and at least one pair of opposed wing structures as at 51. The wing structures 51 are removably receivable in the wing-receiving notches 49 by way of bending (as at 118) the graphic panel 11 as generally demonstrated or depicted in FIG. 11. The wing-receiving notches 49 and wing structures 51 thus cooperate to removably retain the graphic panel 11 in anterior adjacency to the light guide panel 15 (and/or optional diffuser panel 16) within the viewing boundary defined by edging 47.

Similar to display device 10, the low profile backlit graphic display device 10′ according to the present invention also functions to enable a user to display an illuminated graphic panel (as at panel 11′) in anterior adjacency to the user's sternal region (as at 100). To achieve this basic function, the graphic display device 10′ according to the present invention preferably comprises: a posterior housing section as at 12; a light source assembly as at 13; a reflector panel as at 14; a light guide panel as at 15; a diffuser panel as at 16; at least one interchangeable graphic panel as at 11′; and an anterior housing section as at 17′.

Whereas graphic display device 10 incorporates a panel 11 having at least one pair of wing structures 51 for insertion into wing-receiving notches 49 formed in the anterior housing section 17, the graphic display device 10′ incorporates a panel 11′ without wing structures. The panel 11′ is cooperably associated with anterior housing section 17′, which section 17′ comprises a panel-receiving opening as at 56. As illustrated, the opening 56 is formed at the bottom anterior housing edge 44′ for receiving the panel 11′. Certain panel-retaining means (not specifically illustrated) are contemplated for maintaining the panel 11′ in anterior adjacency to the light guide panel 15 (and optional diffuser panel 16).

The lanyard (neck strap) assembly 19 preferably comprises certain coupling means as exemplified by a clip as at 52, and a strap, cord, or lanyard structure as at 53. The lanyard assembly 19 is thus attachable to the coupler receiving aperture 18 (defined by the apertures 46 and 33 of the anterior and posterior housing sections 17 and 12) by way of the coupling means (as exemplified by clip 52) and wearable about the neck 108 of a user by way of the lanyard structure 53 for enabling the user to display a neck-hung illuminated graphic panel 11 or 11′.

It is contemplated that the lanyard assembly 19 may be further outfitted with certain solar power sourcing means for recharging a battery pack 28 of and/or powering the light source assembly 13. In this regard, it is contemplated that a tag 54 may be outfitted with a thin film solar cell material as at 55, which tag-solar cell combination 54/55 may be outfitted upon the lanyard structure 53 and placed into electrical communication with (the light source assembly 13 of) the graphic display devices 10/10′/50 according to the present invention as generally depicted in FIG. 1.

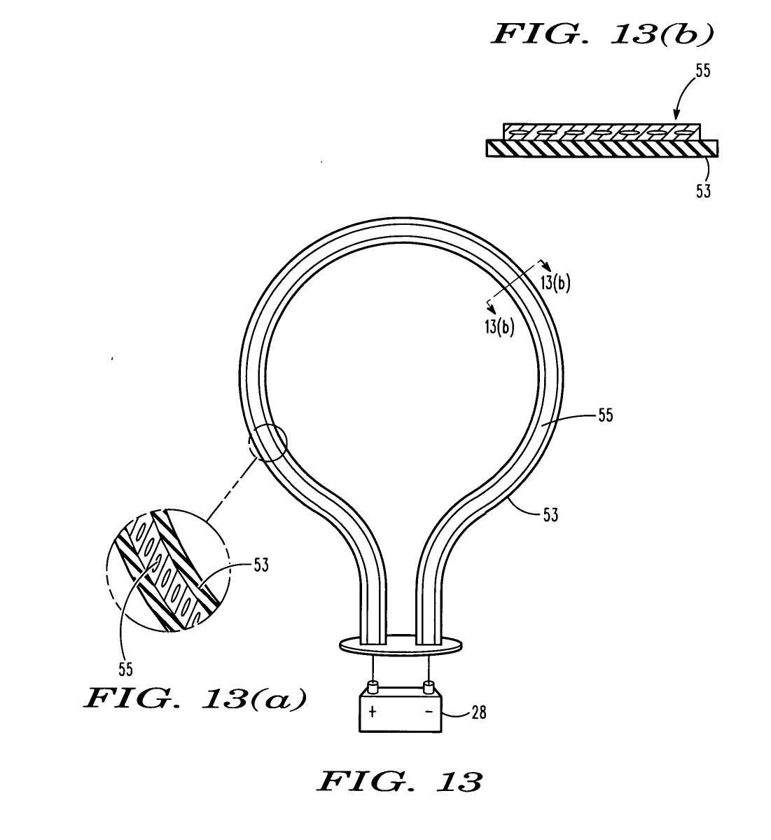

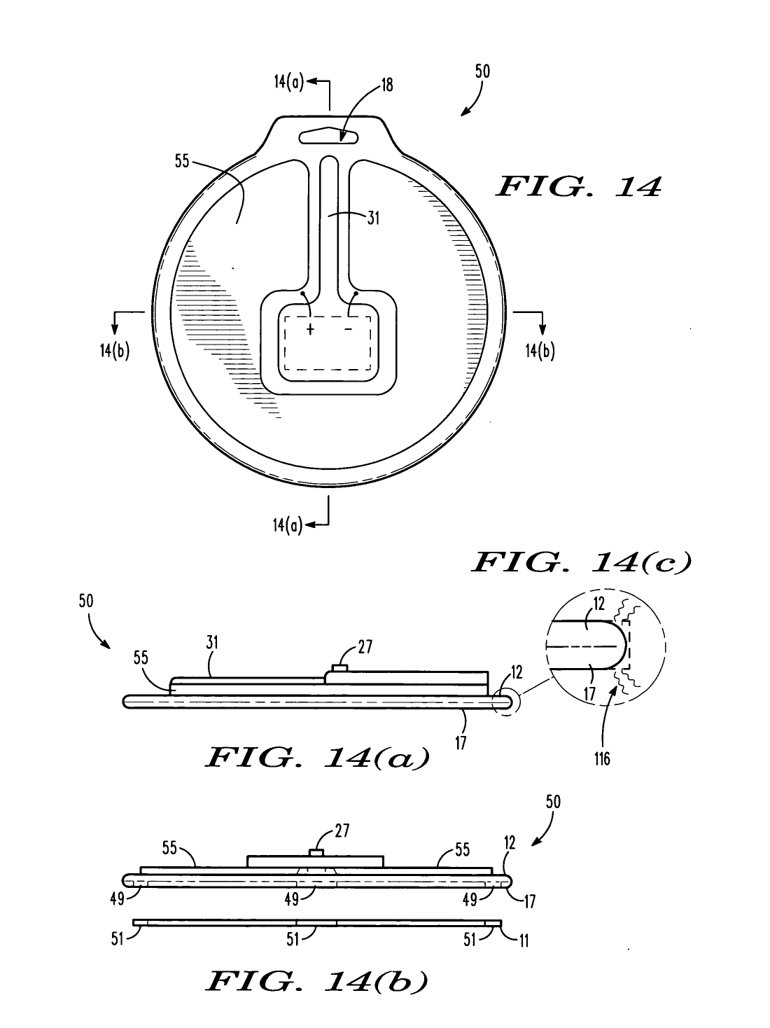

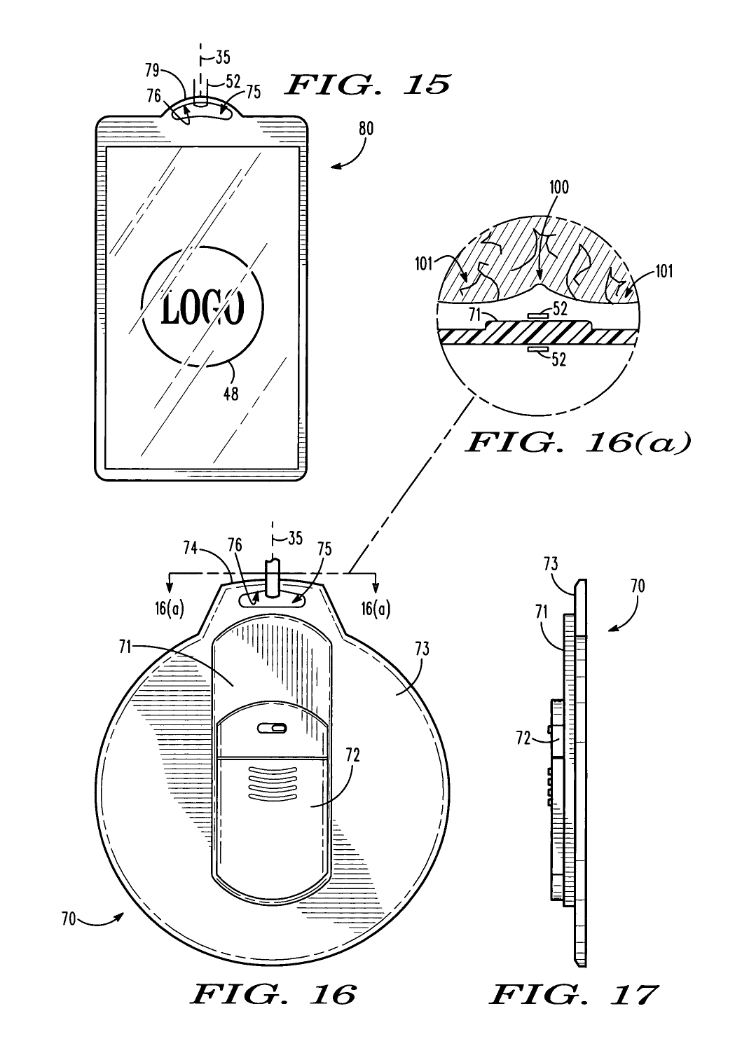

Alternatively, it is contemplated that the lanyard structure 53 may be directly outfitted with a thin film solar cell material 55 as generally depicted in FIGS. 13, 13(a), and 14. This latter alternative structural combination does not require a tag 54 to expose the solar cell material 55 to ambient solar sourced light rays as at 115, and thus may be deemed preferable given certain end user requirements. It is also contemplated that a thin film solar cell material 55 could conceivably be applied to the posterior surfacing of the graphic display device(s) 10/10′/50 as generally depicted with generally circular graphic display device 50 in FIGS. 15, 15(a), and 15(b).

While the foregoing specifications set forth much specificity, the same should not be construed as setting forth limits to the invention but rather as setting forth certain preferred embodiments and features. For example, as prefaced hereinabove, it is contemplated that the presently disclosed inventive subject matter essentially provides a low profile backlit graphic display device for illuminating a graphic or graphic panel.

The graphic display device according to the present invention is believed to essentially comprise a housing assembly, a light source assembly; and a light guide. Other elements usable in combination with the graphic display device according to the present invention are a lanyard assembly as at 19 and at least one interchangeable graphic panel as exemplified by graphic panels 11 and 11′.

The housing assembly preferably comprises certain housing edging, an assembly-receiving cavity, and a lanyard-receiving aperture as at 18. The housing edging defines a light diffusing panel-receiving section in anterior adjacency to an assembly-receiving cavity. The light source assembly comprises, in electrical communication: a power source, a light source, and a switch. The light source assembly is receivable in the assembly-receiving cavity.

The light guide is positionable in anterior adjacency to certain portions of the light source assembly and in inner edge adjacency to the light source(s) of said assembly for guiding light from the light source(s) (1) toward the housing edging and (2) in a generally anterior direction, orthogonal to the plane of the light guide panel 15. The lanyard assembly is attachable to the coupler receiving aperture and wearable about a user's neck for enabling the user to display a neck-hung illuminated graphic.

In addition to the foregoing electromechanical structural considerations, it is contemplated that the same support certain graphic illuminating methodology. In this regard, it is contemplated that the graphic illuminating method according to the present invention may well enable a user to display an illuminated graphic, and thus comprise a series of steps, including provision of a low profile graphic display device of the type heretofore specified.

A graphic may then be removably placed in anterior adjacency to the graphic display device. The graphic display device, having been connected to a lanyard, may thus be hung from a user's neck via the lanyard thereby providing a neck-hung graphic display device. The graphic display device may then be powered ON, and light may be directed through the graphic thereby illuminating the graphic via the neck-hung graphic display device.

The graphic illumination method may further comprise the steps of: centering the graphic display device in anterior adjacency to a user's sterna region intermediate laterally opposed pectoral regions via a posteriorly extending medial bead formed upon graphic display device; and directing light from laterally opposed pocket-positioned light emitting structures toward a medially aligned device plane. In this last regard, it will be recalled that the light emission axes may preferably be orthogonal to laterally opposed light guide entry planes of the light guide and thus the light may be directed along the light emission axes medially or toward the medial plane.

As has been noted, these specifications claim the benefit of pending U.S. patent application Ser. No. 12/821,944 ('944 Application), and Ser. No. 12/930,832 ('832 Application), the specifications of which have been incorporated by reference thereto. In this regard, it is contemplated the present invention may well incorporate certain features otherwise described in previously filed applications to which this application may claim a benefit, inclusive, for example, of certain sensing means, including certain light sensing means and/or motion sensing means as well as certain time-based circuitry and/or certain light dimming means.

Accordingly, although the present invention has been described by reference to certain preferred arrangements and certain methodologies, it is not intended that the novel arrangements and methods be limited thereby, but that modifications thereof are intended to be included as falling within the broad scope and spirit of the foregoing disclosures and the appended drawings.

I claim:

1. A low profile backlit graphic display device for enabling a user to display a neck-hung illuminated graphic, the graphic display device comprising:
a posterior housing section, the posterior housing section comprising a top posterior housing edge, an assembly-receiving cavity, and a panel-receiving section in anterior adjacency to the assembly-receiving cavity, the top edge comprising a medial posterior lanyard-receiving aperture, the assembly-receiving cavity comprising a switch-letting aperture;
a light source assembly, the light source assembly comprising a power source, a light source, and a switch, the power source, light source and switch being in electrical communication with one another, the light source assembly being receivable in the assembly-receiving cavity, the switch being extendable through the switch-letting aperture, the light source being positionable adjacent the top posterior housing edge;
a reflector panel, the reflector panel being positionable in anterior adjacency to the power source and switch in posterior-inferior adjacency to the light source for reflecting light from the light source in an anterior direction;
a light guide panel, the light guide panel being positionable in anterior adjacency to the reflector panel in inferior-edge adjacency to the light source for guiding light from the light source in an anterior direction;
a light-transmissive graphic panel, the graphic panel being positionable in anterior adjacency to the light guide panel for illuminating a graphic by way of guided light from the light guide panel;
an anterior housing section, the anterior housing section comprising a top anterior housing edge, the top anterior housing edge comprising a medial anterior lanyard-receiving aperture, the anterior and posterior housing sections being fastenable to one another such that the anterior and posterior lanyard-receiving apertures define a coupler-receiving aperture; and
a lanyard assembly, the lanyard assembly being attachable to the coupler-receiving aperture and wearable about the neck for enabling the user to display a neck-hung illuminated graphic.

2. The graphic display device of claim 1 comprising a diffuser panel, the diffuser panel being positionable in anterior adjacency to the light guide panel intermediate said light guide and graphic panels for enhancing uniform light transmission through said graphic panel for improving the visual appearance thereof.

3. The graphic display device of claim 2 wherein the posterior housing section comprises laterally opposed light source-receiving cavities, the light source-receiving cavities being laterally opposite the posterior lanyard-receiving aperture, the light source comprising laterally opposed light emitting structures for sourcing light medially.

4. The graphic display device of claim 3 wherein the light guide panel comprises angled upper edging and the light emitting structures each comprise a primary light emitting axis, the angled upper edging being orthogonally opposed to the primary light emitting axes for enhancing light flux guidance through the light guide panel.

5. The graphic display device of claim 4 wherein the anterior housing section comprises a pair of laterally opposed wing-receiving notches and the graphic panel comprises laterally opposed wing structures, the wing structures being removably receivable in the wing-receiving notches for removably retaining the graphic panel in anterior adjacency to the light guide panel.

6. The graphic display device of claim 5 wherein the lanyard assembly comprises solar power sourcing means in electrical communication with the light assembly for collecting and converting solar energy into electrical energy for powering the light assembly.

7. The graphic display device of claim 6 wherein the assembly-receiving cavity extends posteriorly and defines a medial bead, the medial bead for centering the posterior housing section in anterior adjacency to a user's sternal region when donned.

8. A low profile backlit graphic display device for illuminating a graphic panel, the graphic display device comprising:
a housing assembly, the housing assembly comprising housing edging, an assembly-receiving cavity, and a lanyard-receiving aperture, the housing edging defining a panel-receiving section in anterior adjacency to the assembly-receiving cavity;
a light source assembly, the light source assembly comprising, in electrical communication: a power source, a light source, and a switch, the light source assembly being receivable in the assembly-receiving cavity;
a light guide, the light guide being positionable in anterior adjacency to the power source in edge adjacency to the light source for guiding light from the light source in an anterior direction orthogonal to the plane of the light guide; and
a lanyard assembly, the lanyard assembly being attachable to the lanyard-receiving aperture and wearable about a user's neck for enabling a user to display a neck-hung illuminated graphic.

9. The graphic display device of claim 8 comprising a diffuser, the diffuser being positionable in anterior adjacency to the light guide within the panel-receiving section for enhancing uniform light transmission from the light guide.

10. The graphic display device of claim 8 wherein the housing assembly comprises laterally opposed source-receiving cavities, the source-receiving cavities being laterally opposite the lanyard-receiving aperture, the light source comprising laterally opposed light emitting structures for sourcing light medially.

11. The graphic display device of claim 10 wherein the light guide comprises angled upper edging and the light emitting structures each comprise a primary light emitting axis, the angled upper edging being orthogonally opposed to the primary light emitting axes for enhancing light flux guidance through the light guide.

12. The graphic display device of claim 8 comprising, in combination, a graphic panel, the graphic panel comprising wing structures, the housing edging comprising wing-receiving notches for receiving said wing structures for removably retaining the graphic panel in anterior adjacency to the light guide.

13. The graphic display device of claim 8 comprising solar power sourcing means in electrical communication with the light assembly for converting solar energy into electrical energy for powering said light assembly.

14. The graphic display device of claim 13 wherein the solar power sourcing means are affixed to the lanyard assembly such that the lanyard assembly positions the solar power sourcing means adjacent the user's neck when donned.

15. The graphic display device of claim 8 wherein the assembly-receiving cavity extends posteriorly and defines a medial bead, the medial bead for centering posterior portions of the housing assembly in anterior adjacency to a user's sternal region when donned.

16. A graphic display method for enabling a user to display an illuminated graphic, the graphic display method comprising the steps of:
providing a low profile graphic display device;
positioning a graphic in anterior adjacency to the graphic display device;
connecting the graphic display device to a lanyard;
hanging the graphic display device from a user's neck via the lanyard thereby providing a neck-hung graphic display device; and
directing light through the graphic from the neck-hung graphic display device thereby illuminating the graphic.

17. The method of claim 16 comprising the step of centering the neck-hung graphic display device in anterior adjacency to a user's sternal region via a posteriorly extending medial bead formed upon the neck-hung graphic display device.

18. The method of claim 16 comprising the step of directing light medially from laterally opposed pocket positioned light emitting structures before directing light through the graphic.

19. The method of claim 18 comprising the steps of positioning light emission axes and laterally opposed light guide entry planes of a light guide, the light emission axes being orthogonal to the light guide entry planes.

20. The method of claim 16 comprising the step of providing electrical power to the graphic display device via solar energy conversion means cooperably associated with the lanyard.
